(19) United States
(12) Patent Application Publication
(10) Pub. No.: US 2024/0245139 A1
(43) Pub. Date: Jul. 25, 2024

(54) HEATER

(71) Applicant: Nicoventures Trading Limited, LONDON (GB)

(72) Inventor: Shixiang CHEN, London (GB)

(21) Appl. No.: 18/562,670

(22) PCT Filed: May 20, 2022
(86) PCT No.: PCT/GB2022/051282

§ 371 Date: Nov. 20, 2023

(30) Foreign Application Priority Data
May 21, 2021 (GB) 2107322.6

(51) Int. Cl. A24F 40/57; A24F 40/51; A24F 40/53; G05D 23/24

(52) U.S. Cl. CPC A24F 40/57; A24F 40/51; A24F 40/53; G05D 23/2401

(57) ABSTRACT

An apparatus and method comprising: instructing activation of a heater of an aerosol generating device during a calibration procedure, wherein, in normal use, the heater is configured to heat an aerosol generating material to thereby generate an aerosol: obtaining or determining first data corresponding to an electrical characteristic of the heater at each of a plurality of calibration points: obtaining or determining second data corresponding to temperature of the heater at said calibration points: and populating a database with information relating to said first and second data.

### PRIORITY CLAIM

The present application is a National Phase entry of PCT Application No. PCT/GB2022/051282, filed May 20, 2022, which claims priority from GB Application No. 2107322.6, filed May 21, 2021, each of which is hereby fully incorporated herein by reference.

### TECHNICAL FIELD

The present specification relates to calibrating and controlling a heater of an aerosol generating device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol generating substrate such as tobacco to form an aerosol by heating, but not burning, the substrate. The material may, for example, be tobacco or other non-tobacco products, which may or may not contain nicotine.

### SUMMARY

In a first aspect, this specification describes a method comprising: instructing activation of a heater of an aerosol generating device during a calibration procedure, wherein, in normal use, the heater is configured to heat an aerosol generating material to thereby generate an aerosol; obtaining or determining first data corresponding to an electrical characteristic of the heater (e.g. an electrical resistance of the heater) at each of a plurality of calibration points; obtaining or determining second data corresponding to temperature of the heater at said calibration points; and populating a database with information relating to said first and second data. The method may be used for populating a database during a calibration procedure (e.g. during production). The information relating to said first and second data may comprise said first and second data.

In some example embodiments, the database comprises a lookup table for recording a translation between electrical characteristics and temperatures of the heater. The use of a lookup table is one of several options for storing calibration data.

The method may further comprise determining a relationship between the electrical characteristic and the temperature of the heater, wherein said information relating to said first and second data comprises said relationship. The relationship between the electrical characteristic and the temperature of the heater may be a temperature profile. Determining the relationship between the electrical characteristic and the temperature of the heater may comprise updating or scaling an existing temperature profile. Determining the relationship between the electrical characteristic and the temperature of the heater may comprise determining a formula describing said relationship.

Some example embodiments further comprise: repeating the activation of a heater, the obtaining or determining of the electrical characteristic of the heater and the obtaining or determining the temperature of the heater; and updating the determined relationship between the electrical characteristic and the temperature of the heater. Thus, the method may be iterative.

Some example embodiments further comprise controlling the activation of the heater such that, during the calibration procedure, the heater may heat the aerosol generating device from a first temperature at a lower end of a defined temperature range to a second temperature at an upper end of the defined temperature range.

The temperature of the heater may be obtained from one or more non-contact temperature sensors (such as an infra-red sensor). In other example embodiments, the temperature of the heater may be obtained from a contact temperature sensor, such as a thermocouple.

In a second aspect, this specification describes a method comprising: determining an electrical characteristic of a heater (e.g. an electrical resistance of the heater) for heating an aerosol generating material to thereby generate an aerosol; and determining a temperature of the heater based on information describing a relationship between the electrical characteristic and the temperature of the heater stored in a database. The method of the second aspect may make use of calibration data obtained using the method of the first aspect.

The database may comprise a lookup table recording a translation between electrical characteristics and temperatures of the heater. The use of a lookup table is one of several options for storing calibration data.

The relationship between the electrical characteristic and the temperature of the heater may be a temperature profile.

Some example embodiments further comprise driving the heater to control the electrical characteristic (e.g. electrical resistance) such that the temperature of the heater is set to a desired temperature. The electrical characteristic may be controlled until a defined electrical characteristic matching a defined heater temperature is reached.

In a third aspect, this specification describes an apparatus comprising: a heater control module for instructing activation of a heater of an aerosol generating device during a calibration procedure, wherein, in normal use, the heater is configured to heat an aerosol generating material to thereby generate an aerosol; an electrical characteristic module for obtaining or determining first data corresponding to an electrical characteristic of the heater (e.g. an electrical resistance of the heater) at each of a plurality of calibration points; a temperature sensing module for receiving second data corresponding to a temperature of the heater; and a database for storing information relating to said first and second data.

The database may comprise a lookup table for recording a translation between electrical characteristics and temperatures of the heater.

The apparatus may further comprise a processor (or some other means) for determining the information relating the said first and second data.

The information relating the said first and second data may comprise a temperature profile. Determining the relationship between the electrical characteristic and the temperature of the heater may comprise updating or scaling an existing temperature profile. Determining the relationship between the electrical characteristic and the temperature of the heater may comprise determining a formula describing said relationship.

Some example embodiments further comprise a processor (or some other means) for determining a relationship between the electrical characteristic and the temperature of the heater, wherein said information relating to said first and second data comprises said relationship. Determining the relationship between the electrical characteristic and the temperature of the heater may comprise determining a formula describing said relationship.

The heater control module may be configured to control the activation of the heater such that, during the calibration procedure, the heater heats the aerosol generating device from a first temperature at a lower end of a defined temperature range to a second temperature at an upper end of the defined temperature range.

In some example embodiments, the temperature sensing module comprises, or receives signals from one or more temperature sensors. The temperature sensor(s) may comprise one or more non-contact temperature sensors (such as an infra-red sensor) and/or one or more a contact temperature sensors (such as a thermocouple).

In a fourth aspect, this specification describes an apparatus for an aerosol generating device comprising: a heater for heating an aerosol generating material to thereby generate an aerosol; an electrical characteristic determining module for obtaining or determining an electrical characteristic of the heater (e.g. an electrical resistance of the heater); a database storing information describing a relationship between the electrical characteristic and a temperature of the heater; and a heater control module for determining a temperature of the heater based on information describing a relationship (e.g. a temperature profile) between the electrical characteristic and the temperature of the heater stored in a database.

A single control module may implement both the heater control module and the electrical characteristic determining module.

The database may comprise a lookup table storing a translation between electrical characteristics and temperatures of the heater.

The heater control module may control activation of the heater to control the electrical characteristic such that the temperature of the heater is set to a desired temperature. The electrical characteristic may be controlled until a defined electrical characteristic matching a defined heater temperature is reached.

In a fifth aspect, this specification describes a non-combustible aerosol generating device comprising an apparatus as described above with reference to the third or fourth aspects. The aerosol generating device may be configured to receive a removable article comprising an aerosol generating material. The aerosol generating material comprises an aerosol generating substrate and an aerosol forming material. The said apparatus may comprise a tobacco heating system.

In a sixth aspect, this specification describes an electronic smoking article comprising an aerosol generating device as set out above.

In a seventh aspect, this specification describes computer-readable instructions which, when executed by computing apparatus, cause the computing apparatus to perform any method as described with reference to the first or second aspects.

In an eighth aspect, this specification describes a computer program product comprising instructions for causing an apparatus to perform at least one of the following: instruct activation of a heater of an aerosol generating device during a calibration procedure, wherein, in normal use, the heater is configured to heat an aerosol generating material to thereby generate an aerosol; obtain or determine first data corresponding to an electrical characteristic of the heater at each of a plurality of calibration points; obtain or determine second data corresponding to temperature of the heater at said calibration points; and populate a database with information relating to said first and second data.

In a ninth aspect, this specification describes a computer program product comprising instructions for causing an apparatus to perform at least one of the following: determine an electrical characteristic of a heater for heating an aerosol generating material to thereby generate an aerosol; and determine a temperature of the heater based on information describing a relationship between the electrical characteristic and the temperature of the heater stored in a database.

### BRIEF DESCRIPTION OF THE DRAWINGS

Example embodiments will now be described, by way of example only, with reference to the following schematic drawings, in which:

FIG. 1 is a block diagram of an aerosol generating device in accordance with an example embodiment;

FIG. 2 is a block diagram of a heater control system in accordance with an example embodiment;

FIG. 3 is a block diagram of a system in accordance with an example embodiment;

FIGS. 4 and 5 are flow charts showing algorithms in accordance with example embodiments;

FIGS. 6 and 7 are plots demonstrating features of example embodiments;

FIGS. 8 and 9 are flow charts showing algorithms in accordance with example embodiments; and

FIG. 10 is a block diagram of a system in accordance with an example embodiment.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiment, the non-combustible aerosol provision system may comprise an area for receiving the consumable, an aerosol generator, an aerosol generation area, a housing a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

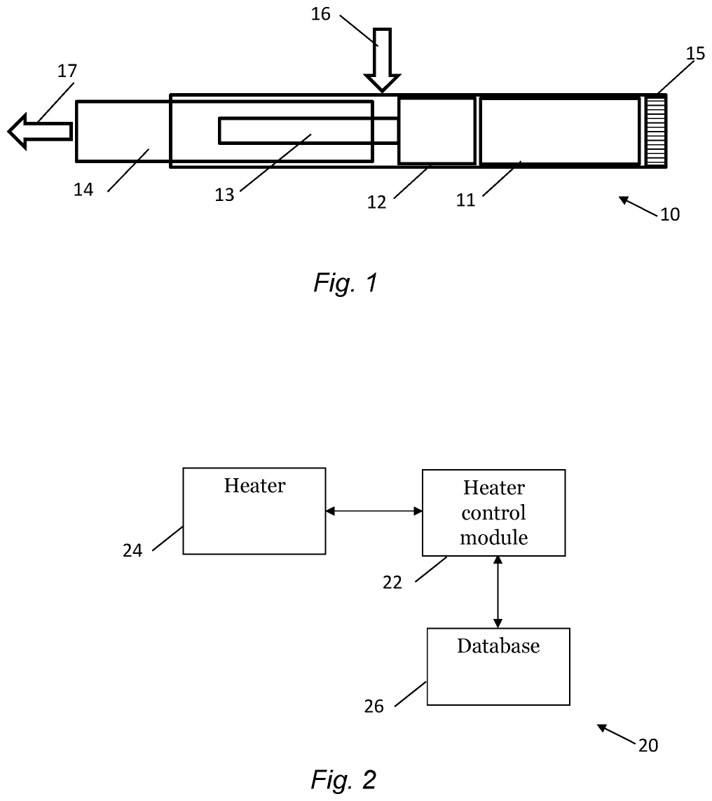

FIG. 1 is a block diagram of an aerosol generating device, indicated generally by the reference numeral 10, in accordance with an example embodiment.

The aerosol generating device 10 comprises a battery 11, a control circuit 12, a heater 13 and a consumable 14 (e.g. a tobacco consumable, for example in the form of a tobacco stick). The device also includes a connector 15 (such as a USB connector). The connector 15 may enable connection to be made to a power source for charging the battery 11, for example under the control of the control circuit 12.

In the use of the device 10, the heater 13 is inserted into the consumable 14, such that the consumable may be heated to generate an aerosol (and tobacco flavor, in the case of a tobacco consumable) for the user. When a user inhales at the end of the consumable, as indicated by arrow 17, the air is drawn into the device 10, through an air inlet as indicated by arrow 16, then passes through the consumable, delivering the aerosol (and tobacco flavor, in the case of a tobacco consumable) to the user.

The aerosol generating device 10 is provided by way of example only. Many alternative aerosol generating devices may be used in example implementations of the principles described here. For example, the device 10 may be replaced within a vaping device in which an aerosol generating material (e.g. a liquid) is heated to generate the aerosol.

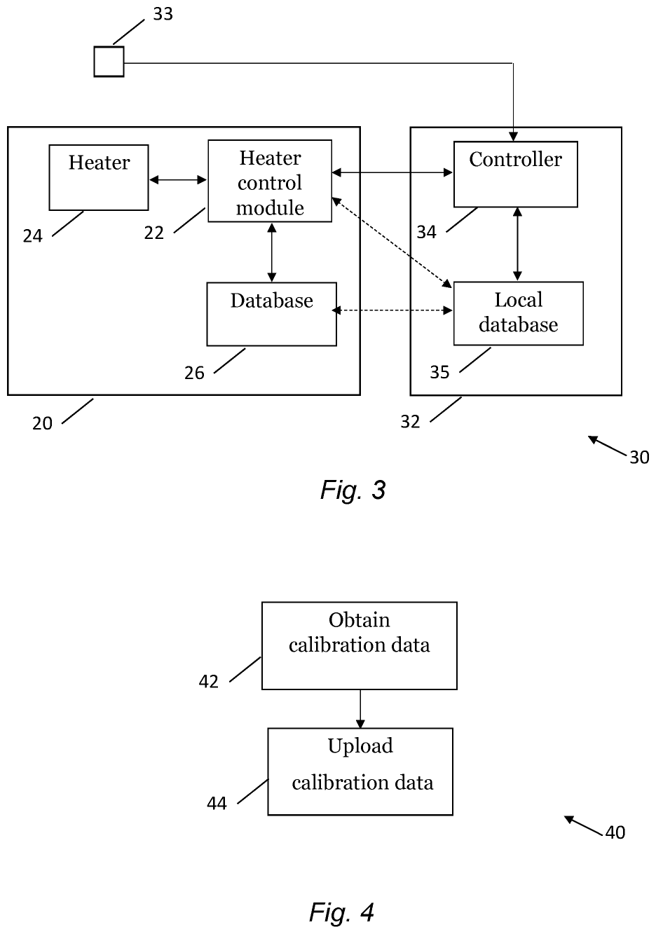

FIG. 2 is a block diagram of a heater control system, indicated generally by the reference numeral 20, in accordance with an example embodiment. The heater control system 20 comprises a heater control module 22, a heater 24 and a database 26.

The heater 24 may be used for heating an aerosol generating material to thereby generate an aerosol. Thus, the heater 24 may be the heater 13 of the aerosol generating device 10 described above. The heater 24 is controlled by the heater control module 22; thus the heater control module 22 may form part of the control circuit 12 of the aerosol generating device 10.

As described in detail below, the database 26 is provided for storing information describing a relationship between an electrical characteristic of the heater (e.g. an electrical resistance) and a temperature of the heater. For example, the database may be populated with information relating to first data corresponding to an electrical characteristic of the heater at each of a plurality of calibration points and second data corresponding to temperature of the heater at said calibration points.

The heater control module 22 seeks to control the temperature of the heater 24. This may be achieved by controlling the electrical characteristic of the heater and using the knowledge of the relationship between the electrical characteristic and the temperature of the heater to indirectly control the heater temperature. In this way, the heater control module 22 can be used to control the temperature of the heater 24 on the basis of the electrical characteristic (which may be determined by the heater control module) without requiring input from a temperature sensor (which might not be available).

As discussed in detail below, the database 26 may comprise a lookup table storing a translation between electrical characteristics of the heater and temperatures of the heater. However, other implementations of the database are possible, such as a mathematical formula or equation.

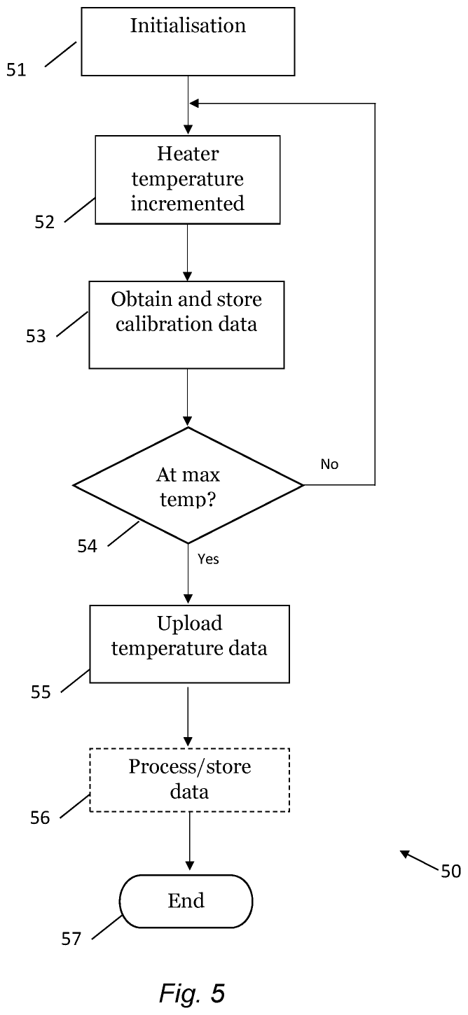

FIG. 3 is a block diagram of a system for temperature calibration, indicated generally by the reference numeral 30, in accordance with an example embodiment.

The system 30 comprises the heater control system 20 described above (including the heater control module 22, the heater 24 and the database 26) and further comprises a calibration sub-system 32 and a temperature sensor 33. The calibration sub-system 32 comprises a controller 34 and a local database 35 that is used by the controller 34 for storing temperature data. During a calibration phase, the controller 34 is in two way communication with the heater control module 22 of the heater control system 20. Further, during the calibration phase the local database 35 may be in communication with the heater control module 22 and/or the database 26; however, this is not essential since data may be passed from the local database 35 to the heater control system 20 via the controller 34 (hence the use of dotted arrows in FIG. 3).

The calibration sub-system 32 may be used as an external test system for measuring heater temperature independently based on a signal from the temperature sensor 33. The calibration sub-system 32 may able to send measurement results to the database 26 for storage and may also able to determine when temperature measurements should take place during a calibration process.

The heater control module 22 controls the activation of the heater 24 of the heater control system 20 in either a normal operational mode (e.g. where the heater 24 is configured to heat a consumable or some other aerosol generating material to thereby generate an aerosol) or in a calibration mode. The database 26 stores data relating to the relationship between the electrical characteristic and the temperature of the heater that may be used by the heating control module 22 (in the normal mode of operation) to set the heater 24 to a desired temperature based on an electrical characteristic of the heater, as determined by the heater control module 22.

The temperature sensor 33 is a non-contact temperature sensor (e.g. an infra-red camera) that is placed close to the heater 24. In some example embodiments, the heater 24 is visible to the temperature sensor 33. For example, a casing or enclosure of the system 20 may be removable during a calibration mode of operation. Alternatively, the calibration phase may be performed, during production, before the casing or enclosure of the system 20 is provided. It should be noted that, as discussed below, the use of a non-contact temperature sensor is not essential to all example embodiments.

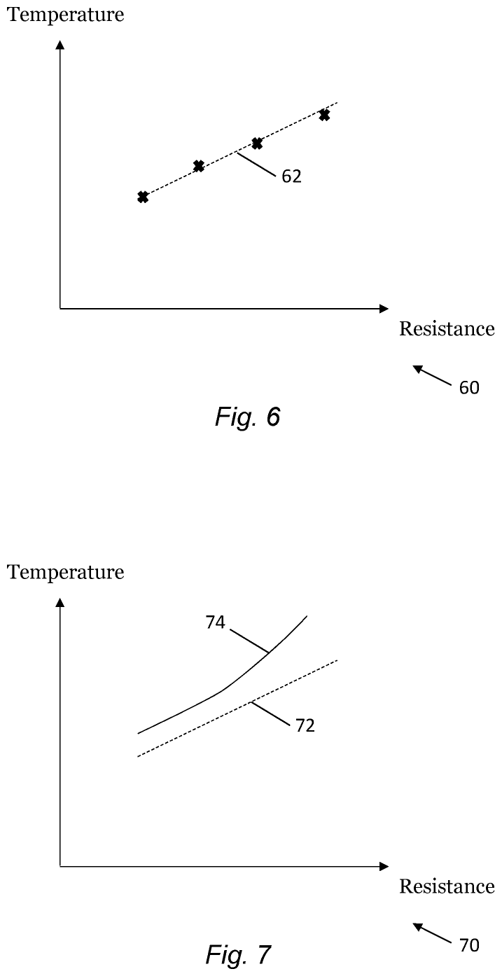

FIG. 4 is a flow chart showing a calibration algorithm, indicated generally by the reference numeral 40, in accordance with an example embodiment. The algorithm 40 may be implemented by the system 30 described above in an example calibration process.

The algorithm 40 starts at operation 42, where calibration data is obtained. The calibration data comprise an electrical characteristic (e.g. electrical resistance) of the heater 24 and a temperature of the heater 24. The electrical characteristic may be determined by the heater control module 22 and stored at the database 26 and the temperature may be obtained at the controller 34 (e.g. from the temperature sensor 33) and stored at the local database 35. As discussed further below, the operation 42 may be an iterative process.

At operation 44, the relevant calibration data are uploaded to the database 26 upon the completion of temperature measurement using temperature sensor 33. The operation 44 may include the entire temperature data stored at the local database 35 being uploaded to the database 26. Alternatively, or in addition, the operation 44 may include the calibration data being processed at the same time as the temperature measurement is performed, and the processed data may be uploaded and stored at the database 26 in real time.

The algorithm 40 may be implemented during production of an aerosol generating device (such as the device 10 described above). Thus, when production of the aerosol generating device is finished (e.g. when the device is shipped), the device is calibrated to enable the heater control module 22 to control the heater 24 in the normal operation of the aerosol generating device.

FIG. 5 is a flow chart showing an algorithm, indicated generally by the reference numeral 50, in accordance with an example embodiment. The algorithm 50 describes a method for generating calibration data and storing the calibration data at the database 26 during a calibration procedure (thereby providing an example implementation of the algorithm 40). The algorithm 50 may be implemented at both the heater control system 20 and the calibration sub-system 32 as discussed further below.

The calibration algorithm 50 starts at operation 51, where an initialization process takes place. For example, the heater 24 may be activated. During the initialization process, the heater 24 may be initialized to a starting temperature (e.g. a low temperature, such as a lower target temperature of a calibration temperature range).

At operation 52, the temperature of the heater 24 is increased during a heater temperature incrementing step. The operation 24 may be implemented by the heater control module 22, for example in response to instructions from a calibration sub-system 32.

In response to the heating (and possibly after a time delay to allow for temperatures and resistances to settle), the algorithm moves to operation 53, where calibration data are obtained and stored. As part of the operation 53 an electrical resistance of the heater 24 may be determined by the heater control module 22 and an associated temperature of the heater may be determined by the calibration sub-system 32.

As part of the operation 53, the resistance and temperature data points may be stored locally (e.g. relevant databases may be populated with those data). For example, the resistance of the heater may be stored at the database 26 and the temperature of the heater (that corresponds to that resistance) may be stored at the local database 35.

At operation 54, a determination is made regarding whether a maximum temperature of the calibration process has been reached. The operation 54 may, for example, include determining whether a defined number of iterations have been implemented or determining whether an upper target temperature of a calibration temperature range has been reached (or exceeded).

If it is determined in the operation 54 that the maximum temperature has not been reached (i.e. the calibration algorithm in not completed), then the algorithm returns to operation 52 such that further data points can be collected. The heater temperature is then incremented and further calibration data obtained and stored in a further iteration of the operations 52 and 53. Thus, the heater can be activated and controlled during the calibration procedure, such that the aerosol generating device is heated from a first temperature at a lower end of a temperature range to a second temperature at an upper end of the temperature range.

If it is determined in the operation 54 that the calibration is complete, then the algorithm moves to operation 55, where temperature data as stored at the calibration sub-system 32 are uploaded to the heater control system 20 for storage (at the database 26) together with the associated heater resistance data. In this way, the database 26 can be used as a database of resistances and temperatures which describes the relationship between resistance and temperature for the device being calibrated. For example, the database may be populated with some or all of the data stored locally in each iteration of the operation 53. Alternatively, or in addition, the data (e.g. raw data) stored in the iterations of the operation 53 may be processed in an optional operation 56 of the algorithm 50 before the database is populated. For example, a temperature profile or a formula described a temperature profile may be generated and uploaded to the database.

With the relevant data uploaded, the algorithm 50 terminates at operation 57.

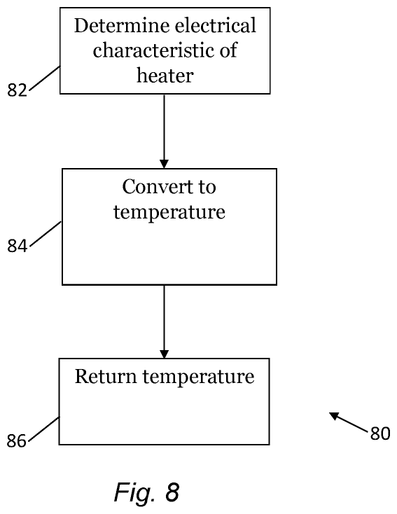

FIG. 6 is a plot, indicated generally by the reference numeral 60, demonstrating a feature of an example embodiment. The plot shows four electrical resistance-temperature data pairs and a line 62 demonstrating a linear relationship between those data points.

Each of the electrical resistance-temperature data pairs shown in the plot 60 may be generated by an instance of the operation 53 of the algorithm 50. The line 62 may be generated in the operation 56 (in which the linear relationship between temperature and resistance may be determined). It should be noted that the plot 60 is provided by way of example only. For example, the relationship between resistance and temperature may not be linear, as discussed further below.

In the operation 55 of the algorithm 50 described above, calibration data is uploaded to a database 26 of the heater control system 20 of an aerosol generating device being calibrated. The calibration data may comprise the data points shown in the plot 60. Alternatively, or in addition, the calibration data may comprise the line 62 of the plot 60 (which line may be referred to as a temperature profile). In some example embodiments, the calibration data comprise a formula describing the relationship between the electrical characteristic and the temperature of the heater (such as the formula of the line 62).

FIG. 7 is a plot, indicated generally by the reference numeral 70, demonstrating a feature of an example embodiment.

The plot 70 shows a first temperature profile 72 demonstrating an anticipated temperature profile and a second temperature profile 74 demonstrating a measured temperature profile.

As shown in the plot 70, the measured temperature profile 74 differs from the expected temperature profile. For example, the expected temperature profile 72 is linear over the temperature range shown and the measured temperature profile 74 is non-linear. Moreover, the measured temperature profile is higher than the expected temperature profile over the entire measured temperature range.

In the event that the expected temperature profile is known to aerosol generating device being calibrated, the operation 56 may process the calibration data (e.g. in the operation 56) by updating or scaling the expected temperature profile.

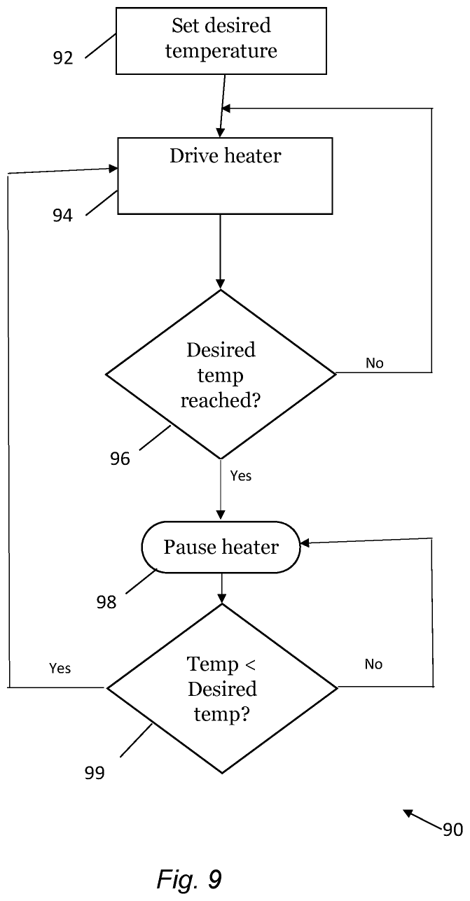

FIG. 8 is a flow chart showing an algorithm, indicated generally by the reference numeral 80, in accordance with an example embodiment. The algorithm 80 is directed to an example use of a calibrated temperature relationship and may be implemented by a heater control module 22 of an aerosol generating device.

The algorithm 80 starts at operation 82 where an electrical characteristic of a heater for heating an aerosol generating material to thereby generate an aerosol is determined. The electrical characteristic may be an electrical resistance of the heater. The heater may be the heater 24 of the system 20 described above and the electrical characteristic may be determined by the heater control module 22.

At operation 84, information describing a relationship between the electrical characteristic and a temperature of the heater is retrieved, for example from a database or lookup table (e.g. the database 26 of the system 20) and used to convert the electrical characteristic determined in the operation 82 into a temperature.

At operation 86, the determined temperature is returned. The temperature may, for example, by used by a control module (such as the heater control module 22) to control a heater (such as the heater 24).

FIG. 9 is a flow chart showing an algorithm, indicated generally by the reference numeral 90, in accordance with an example embodiment. The algorithm 90 is directed to an example use of a calibrated temperature relationship and may be implemented by a heater control module 22 of an aerosol generating device.

The algorithm 90 starts at operation 92 where a desired heater temperature for the desired aerosol delivery is set. For example, the heater control module 22 may set a desired operational temperature of the heater 24.

At operation 94, a heater (such as the heater 24) is driven in order to achieve the desired heater temperature set in the operation 92.

At operation 96, a determination is made regarding whether the desired heater temperature set in the operation 92 has been reached (or exceeded). For example, the algorithm 80 may be used to determine the temperature based on an electrical characteristic of the heater.

If the desired heater temperature has not yet been reached, the algorithm 90 returns to operation 94, where the heater continues to be driven. If the desired heater temperature has been reached, the algorithm 90 pauses the heater activation at operation 98.

At operation 99, a determination is made regarding whether the heater temperature has dropped below a desired temperature after operation 98 by checking the heater resistance. If it has, the algorithm 90 returns to operation 94 where the heater (such as the heater 24) is activated again in order to regain the desired heater temperature set in the operation 92. Therefore, the heater temperature is maintained at the desired heater temperature. If the temperature has not dropped below the desired temperature, the algorithm 90 returns to operation 98.

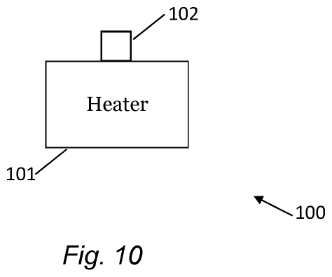

As discussed above, the temperature sensor 33 may be a non-contact temperature sensor (such as an infra-red camera). This is not essential to all example embodiments. For example, FIG. 10 is a block diagram of a system, indicated generally by the reference numeral 100, in accordance with an example embodiment. The system 100 comprises a heater 101 (such as the heater 24 described above) and a temperature sensor 102. The temperature sensor 102 is a contact temperature sensor (e.g. a thermocouple). In the system 100, the temperature sensor 102 is in contact with the heater 101 and can therefore be used to make temperature measurements.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A method comprising:
instructing activation of a heater of an aerosol generating device during a calibration procedure, wherein, in normal use, the heater is configured to heat an aerosol generating material to thereby generate an aerosol;
obtaining or determining first data corresponding to an electrical characteristic of the heater at each of a plurality of calibration points;
obtaining or determining second data corresponding to temperature of the heater at said calibration points; and
populating a database with information relating to said first and second data.

2. A method as claimed in claim 1, wherein said information relating to said first and second data comprises said first and second data.

3. A method as claimed in claim 1, wherein the database comprises a lookup table for recording a translation between electrical characteristics and temperatures of the heater.

4. A method as claimed in claim 1, further comprising determining a relationship between the electrical characteristic and the temperature of the heater, wherein said information relating to said first and second data comprises said relationship.

5. A method as claimed in claim 4, wherein the relationship between the electrical characteristic and the temperature of the heater is a temperature profile.

6. A method as claimed in claim 5, wherein determining the relationship between the electrical characteristic and the temperature of the heater comprises updating or scaling an existing temperature profile.

7. A method as claimed in claim 4, wherein determining the relationship between the electrical characteristic and the temperature of the heater comprising determining a formula describing said relationship.

8. A method as claimed in claim 1, further comprising:
repeating the activation of a heater, the obtaining or determining of the electrical characteristic of the heater and the obtaining or determining the temperature of the heater; and
updating the determined relationship between the electrical characteristic and the temperature of the heater.

9. A method as claimed in claim 1, further comprising controlling the activation of the heater such that, during the calibration procedure, the heater heats the aerosol generating device from a first temperature at a lower end of a defined temperature range to a second temperature at an upper end of the defined temperature range.

10. A method as claimed in claim 1, wherein the temperature of the heater is obtained from one or more non-contact temperature sensors.

11. A method comprising:
determining an electrical characteristic of a heater for heating an aerosol generating material to thereby generate an aerosol; and
determining a temperature of the heater based on information describing a relationship between the electrical characteristic and the temperature of the heater stored in a database.

12. A method as claimed in claim 11, wherein the database comprises a lookup table recording a translation between electrical characteristics and temperatures of the heater.

13. A method as claimed in claim 11, wherein the relationship between the electrical characteristic and the temperature of the heater is a temperature profile.

14. A method as claimed in claim 11, further comprising driving the heater to control the electrical characteristic such that the temperature of the heater is set to a desired temperature.

15. A method as claimed in claim 14, wherein the electrical characteristic is controlled until a defined electrical characteristic matching a defined heater temperature is reached.

16. An apparatus comprising:
a heater control module for instructing activation of a heater of an aerosol generating device during a calibration procedure, wherein, in normal use, the heater is configured to heat an aerosol generating material to thereby generate an aerosol;
an electrical characteristic module for obtaining or determining first data corresponding to an electrical characteristic of the heater at each of a plurality of calibration points;
a temperature sensing module for receiving second data corresponding to a temperature of the heater; and
a database for storing information relating to said first and second data.

17. An apparatus as claimed in claim 16, wherein the database comprises a lookup table for recording a translation between electrical characteristics and temperatures of the heater.

18. An apparatus as claimed in claim 16, further comprising a processor for determining the information relating the said first and second data.

19. An apparatus as claimed in claim 16, wherein the information relating the said first and second data comprises a temperature profile.

20. An apparatus as claimed in claim 16, further comprising a/the processor for determining a relationship between the electrical characteristic and the temperature of the heater, wherein said information relating to said first and second data comprises said relationship.

21. An apparatus as claimed in claim 16, wherein the heater control module is configured to control the activation of the heater such that, during the calibration procedure, the heater heats the aerosol generating device from a first temperature at a lower end of a defined temperature range to a second temperature at an upper end of the defined temperature range.

22. An apparatus as claimed in claim 16, wherein the temperature sensing module comprises, or receives signals from one or more temperature sensors.

23. An apparatus for an aerosol generating device comprising:
a heater for heating an aerosol generating material to thereby generate an aerosol;
an electrical characteristic determining module for obtaining or determining an electrical characteristic of the heater;
a database storing information describing a relationship between the electrical characteristic and a temperature of the heater; and
a heater control module for determining a temperature of the heater based on information describing a relationship between the electrical characteristic and the temperature of the heater stored in a database.

24. An apparatus as claimed in claim 23, wherein the database comprises a lookup table storing a translation between electrical characteristics and temperatures of the heater.

25. An apparatus as claimed in claim 23, wherein the heater control module is for controlling activation of the heater to control the electrical characteristic such that the temperature of the heater is set to a desired temperature.

26. A method as claimed in claim 1, wherein the electrical characteristic is an electrical resistance of the heater.

27. A non-combustible aerosol generating device comprising an apparatus as claimed in claim 16.

28. A computer program product comprising instructions for causing an apparatus to perform at least one of the following:
instruct activation of a heater of an aerosol generating device during a calibration procedure, wherein, in normal use, the heater is configured to heat an aerosol generating material to thereby generate an aerosol;
obtain or determine first data corresponding to an electrical characteristic of the heater at each of a plurality of calibration points;
obtain or determine second data corresponding to temperature of the heater at said calibration points; and
populate a database with information relating to said first and second data.

29. A computer program product comprising instructions for causing an apparatus to perform at least one of the following:
determine an electrical characteristic of a heater for heating an aerosol generating material to thereby generate an aerosol; and
determine a temperature of the heater based on information describing a relationship between the electrical characteristic and the temperature of the heater stored in a database.
